(19) United States
(12) Patent Application Publication
(10) Pub. No.: US 2002/0194296 A1
(43) Pub. Date: Dec. 19, 2002

(54) Stopping a slow download of internally included objects in a downloaded HTML page on a web client

(75) Inventors: Rabindranath Dutta, Austin, TX (US); Kamal Chandrakant Patel, Cedar Park, TX (US)

Correspondence Address: Marilyn Smith Dawkins, International Business Machines Corporation, Intellectual Property Law Department, 11400 Burnet Road, Internal Zip 4054, Austin, TX, 78758, US

(73) Assignee: International Business Machines Corporation

(21) Appl. No.: 09/881,924

(22) Filed: Jun. 14, 2001

(51) Int. Cl. G06F 15/173; G06F 15/16

(52) U.S. Cl. 709/217; 709/224

(57) ABSTRACT

The system, method and program of the invention enhances the stop button on a Web page to enable a user to specifically select which included objects the user desires to stop downloading. More specifically, if during the downloading of a Web page a user determines that the page is not loaded fully, the user enables the stop button (e.g., clicks on the stop button using a right mouse button). A popup window appears showing an identification of the included objects and a percentage amount that each object is loaded. The user has an option to select from among the identified objects. In response to a selection, the downloading of a selected object will be stopped.

### BACKGROUND OF THE INVENTION

1. Field of the Invention

This invention relates to accessing Web pages over the Internet, and more specifically to a system, method and program for stopping a slow download of internally included objects in a downloaded HTML page on a Web client.

2. Description of the Related Art

As computational devices continue to proliferate throughout the world, there also continues to be an increase in the use of networks connecting these devices. Computational devices include large mainframe computers, workstations, personal computers, laptops and other portable devices including wireless telephones, personal digital assistants, automobile-based computers, etc. Such portable computational devices are also referred to as “pervasive” devices. The term “computer” or “computational device”, as used herein, may refer to any of such device which contains a processor and some type of memory.

The computational networks may be connected in any type of network including the Internet, an intranet, a local area network (LAN) or a wide area network (WAN). The networks connecting computational devices may be “wired” networks, formed using lines such as copper wire or fiber optic cable, wireless networks employing earth and/or satellite-based wireless transmission links, or combinations of wired and wireless network portions. Many such networks may be organized using a client/server architecture, in which “server” computational devices manage resources, such as files, peripheral devices, or processing power, which may be requested by “client” computational devices. “Proxy servers” can act on behalf of other machines, such as either clients or servers.

A widely used network is the Internet. The Internet, initially referred to as a collection of “interconnected networks”, is a set of computer networks, possibly dissimilar, joined together by means of gateways that handle data transfer and the conversion of messages from the sending network to the protocols used by the receiving network. When capitalized, the term “Internet” refers to the collection of networks and gateways that use the TCP/IP suite or protocols.

Currently, the most commonly employed method of transferring data over the Internet is to employ the World Wide Web environment, referred to herein as “the Web”. Other Internet resources exist for transferring information, such as File Transfer Protocol (FTP) and Gopher, but have not achieved the popularity of the Web. In the Web environment, servers and clients effect data transfer using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML).

In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”.

A browser is a program capable of submitting a request for information identified by an identifier, such as, for example, a URL, receiving the requested information or page identified by the URL, and rendering the requested page on a display.

Often, images and other objects are included in HTML web pages downloaded from a server. In some instances, these internal objects can take a long time to download. Consequently, this makes a user wait for a long time at the Web client. The problem is particularly acute when embedded objects are downloaded from sites that are external to the owner of the Web server of the parent HTML. The problem will become even more exacerbated as individuals put up their personal Web servers at home that have limited bandwidth for connection.

Currently, when users get tired of waiting for a Web page to download completely, the stop button on a Web page is used. However, the prior art stop button stops the download of all of the internal objects.

### SUMMARY OF THE INVENTION

It is therefore an object of the invention to enhance the presently used stop button to enable selected ones of the included objects to be stopped from being downloaded.

The system, method and program of the invention enhances the stop button on a Web page to enable a user to specifically select which included objects the user desires to stop downloading. More specifically, if during the downloading of a Web page a user determines that the page is not loaded fully, the user enables the stop button (e.g., clicks on the stop button using a right mouse button). A popup window appears showing an identification of the included objects and a percentage amount that each object is loaded. The user has an option to select from among the identified objects. In response to a selection, the downloading of a selected object will be stopped.

As such, selected objects within a group of objects being downloaded can be individually stopped from being downloaded. This is more advantageous than the prior art implementation of the stop button which stopped the download of all of the included objects.

### BRIEF DESCRIPTION OF THE DRAWINGS

For a more complete understanding of the present invention and the advantages thereof, reference should be made to the following Detailed Description taken in connection with the accompanying drawings in which:

FIG. 1 illustrates a network environment in which a browser program of a preferred embodiment of the invention resides at a client within the network;

FIG. 2 illustrates a block diagram of a browser program;

FIG. 3 is a process flow diagram illustrating the logic of a preferred embodiment of the invention;

FIG. 4A illustrates a downloading of a Web page having included objects of a preferred embodiment of the invention; and

FIG. 4B illustrates a popup window having selectable objects in response to a selection of a stop button in the browser GUI of a preferred embodiment of the invention.

### DETAILED DESCRIPTION OF THE PREFERRED EMBODIMENTS

In the following description, reference is made to the accompanying drawings which form a part hereof, and which illustrate several embodiments of the present invention. It is understood that other embodiments may be utilized and structural and operational changes may be made without departing from the scope of the present invention.

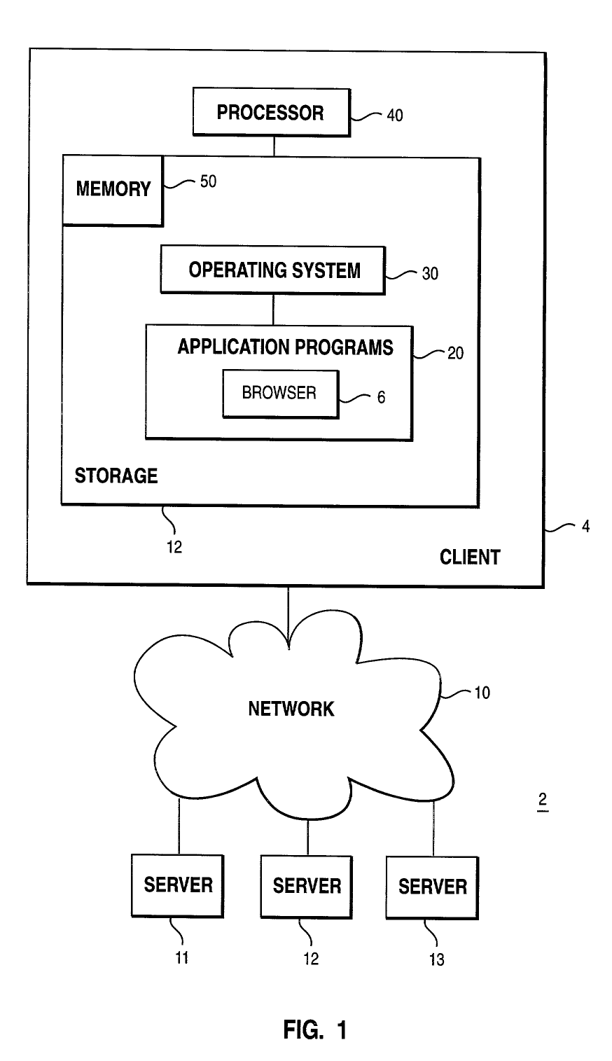

With reference to the figures, and in particular with reference now to FIG. 1, a high-level block diagram of a network computing environment in which a preferred embodiment of the present invention may be implemented is depicted. The computing environment 2 includes at least one client computer 4 including a browser program or viewer program 6, such as the Microsoft Internet Explorer or Netscape Navigator, that is capable of retrieving files from servers 11, 12, 13 over a network 10. The client computer 4 may comprise any computer system known in the art capable of executing a browser program. The servers 11, 12, 13 may comprise any computer system known in the art capable of maintaining files and making such files accessible to remote computers. The browser program 6 and servers 11, 12, 13 communicate using a document transfer protocol such as the Hypertext transfer Protocol (HTTP), or any other document transfer protocol known in the art, such as FTP, Gopher, WAIS, etc. The network 10 may be made up of a TCP/IP network, such as the Internet and World Wide Web, or any network system known in the art, e.g., LAN, Ethernet, WAN, System Area Network (SAN), Token Ring, etc..

The client computer 4 may be, but is not limited to, a personal computer, laptop, workstation, mainframe, or hand held computer including palmtops, personal digital assistant, smart phones, web enabled cellular phones, etc.. Client computer includes processor 40 and memory 50. Memory 50 includes volatile or nonvolatile storage and/or any combination thereof. Volatile memory may be any suitable volatile memory device, e.g., RAM, DRAM, SRAM, etc.. Nonvolatile memory may include storage space 12, e.g., via the use of hard disk drives, tapes, etc., for data, databases, and programs. The programs in memory include an operating system 30 and application programs 20 including a browser program 6. The browser program 6 displays a graphical user interface in which content from a file downloaded from one of the servers 11, 12, 13, such as a HTML page, is displayed. The browser GUI displays graphical buttons to perform operations related to the files downloaded from a server as further described herein.

The client computer 4 includes output devices (not shown) including a display for displaying the browser GUI and Web page and object content. The client computer also includes at least one input device (not shown) through which the user may enter input data to control the operation of the browser program 6, such as a keyboard, mouse, pen-stylus, touch sensitive screen, voice decoder for decoding voice commands, etc.. In preferred embodiments, a user at the client computer 4 can input commands to control the browser program 6 through the graphical user interface (GUI) generated by the browser program 6 or input device controls, such as keyboard keys, mouse buttons, touch pad regions, that are programmed to cause the browser program to perform specific operations.

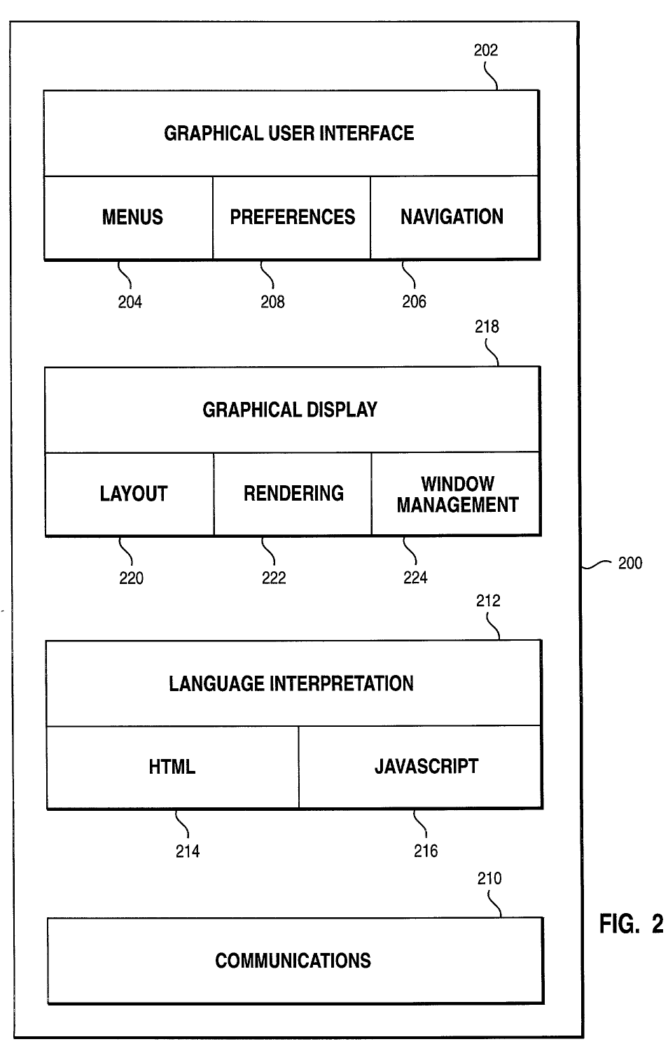

FIG. 2 is an exemplary block diagram of a browser program in accordance with a preferred embodiment of the present invention. A browser program is an application used to navigate or view information or data in a network environment, such as the Internet or the World Wide Web.

In this example, browser program 200 includes a user interface 202, which is a graphical user interface (GUI) that allows the user to interface or communicate with browser program 200. This interface provides for selection of various functions through menus 204 and allows for navigation through navigation 206. For example, menu 204 may allow a user to perform various functions, such as saving a file, opening a new window, displaying a history, and entering a URL. Navigation 206 allows for a user to navigate various pages and to select Web sites for viewing. For example, navigation 206 may allow a user to see a previous page or a subsequent page relative to the present page. Preferences may be set through preferences 208.

Communications 210 is the mechanism with which browser program 200 receives documents and other resources from a network such as the Internet. Further, communications 210 is used to send or upload documents and resources onto a network. In the depicted example, communications 210 uses HTTP. Other protocols may be used depending on the implementation. Documents that are received by browser program 200 are processed by language interpretation 212, which includes an HTML unit 214 and a JavaScript unit 216. Language interpretation 212 will process a document for presentation on graphical display 218. In particular, HTML statements are processed by HTML unit 214 for presentation while JavaScript statements are processed by JavaScript unit 216.

Graphical display 218 includes layout unit 220, rendering unit 222, and window management 224. These units are involved in presenting Web pages to a user based on results from language interpretation 212.

Browser program 200 is presented as an example of a browser program in which the present invention may be embodied. Browser program 200 is not meant to imply architectural limitations to the present invention. Presently available browsers may include additional functions not shown or may omit functions shown in browser program 200. A browser program may be any application that is used to search for and display content in a network environment. Browser program 200 may be implemented using known browser applications, such as Netscape Navigator or Microsoft Internet Explorer. Netscape Navigator is available from Netscape Communications Corporation while Microsoft Internet Explorer is available from Microsoft Corporation.

The exemplary embodiments shown in FIGS. 1 and 2 are provided solely for the purposes of explaining the preferred embodiments of the invention; and those skilled in the art will recognize that numerous variations are possible, both in form and function.

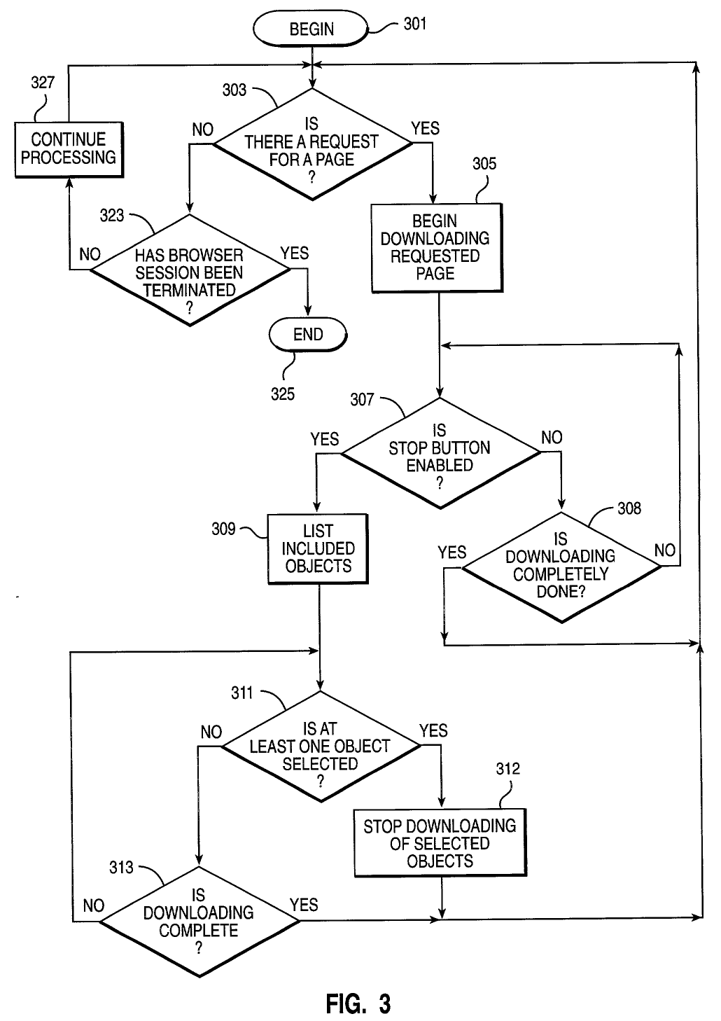

FIG. 3 is a process flow diagram illustrating the logic of a preferred embodiment of the invention. The process begins at 301 when the browser program is executed. A processing loop continually determines whether or not there is a request for a Web page 303. If a Web page is not being requested, the processing loop continually determines whether or not an indication is received to terminate the browser session 323. If an indication is received to terminate the browser session, the session ends 325. As long as an indication to terminate the browser program is not received, the browser program continues processing 327 while determining whether or not a Web page is being requested 303.

If a request for a Web page is made 303, the browser program running at the client, or a proxy server communicatively connected to the browser program, begins to download the requested Web page 305. During the download, the browser program determines if the stop button is enabled 307. If the stop button is not enabled, then it is determined if downloading is complete 308. If downloading is complete, then processing continues back to the beginning 303 of the process. If downloading is not complete 308, the process continues to determine if the stop button is enabled 307. If the stop button is enabled, then the GUI of the browser program presents to the user a popup window showing the list of objects included in the requested Web page that are currently being downloaded 309. Another loop is encountered until it is determined whether at least one object is selected from the popup list 311 or downloading is complete 313. If downloading was completed for the requested page 313; then the process continues back at 303 and 323 waiting for either a request for a new page or termination of the browser program, respectively.

If it is determined that at least one object has been selected 311, then the downloading of the selected objects is stopped from proceeding any further 312.

In one embodiment, any partially downloaded object may be rendered in conjunction with the rendering of the requested page. In another embodiment, if the downloading of an included object was stopped, whatever partial data of the object was actually received by the client will be discarded, and no portion of the selected objects will be rendered. In yet another embodiment, whether or not a user wants the partial object to be displayed will be selectable by the user either as a configurable user preference for all future events that stop the downloading of selectable objects, or as a selectable item in a GUI dialog in response to each specific occurrence of the event.

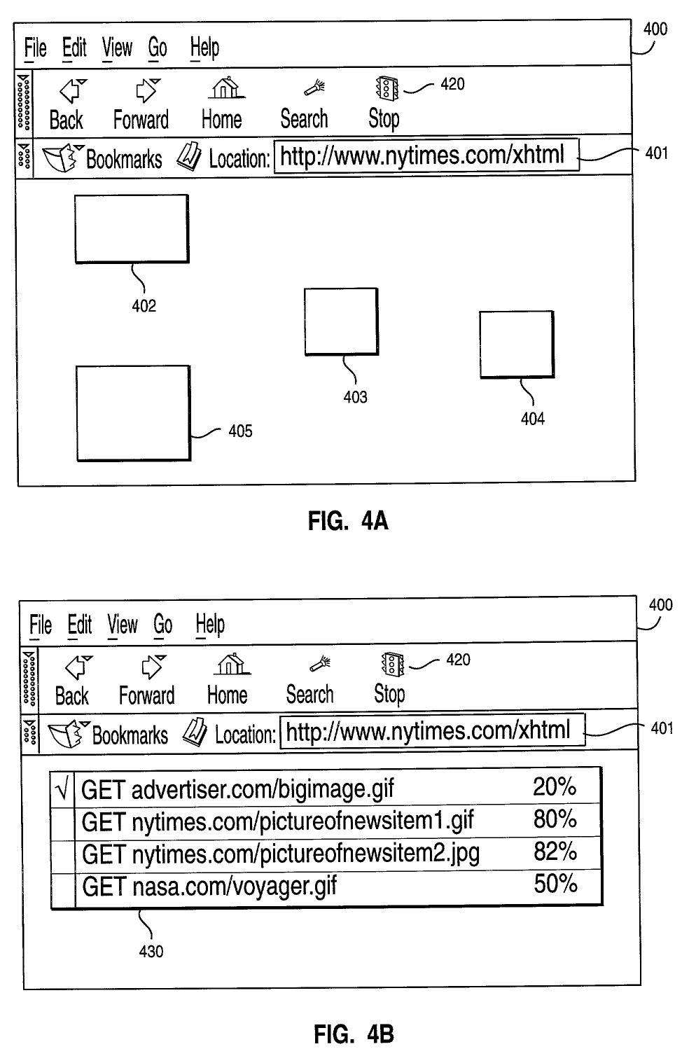

For example, FIG. 4A shows a browser program 400 downloading a requested Web page www.nytimes.com/x.html 401 which contains four images:

www.advertiser.com/bigimage.gif 402 [very slow]

www.nytimes.com/pictureofnewsitem1.gif 403 [fast]

www.nytimes.com/pictureofnewsitem2.jpg 404 [fast]

www.nasa.com/voyager.gif 405 [slow]

The browser client does HTTP GETS on each of the included objects mentioned above. It is noted, for this example, that the relative download times for each of the above objects are indicated in brackets above.

If at any time the user no longer wants to wait for the requested Web page 401 to be fully loaded, including each of the included objects 402-405, the user clicks STOP 420 on the browser GUI with a click of the right mouse button or through the use of any other input device enabling user selections. As a result of selecting the stop button 420, a popup window 430 appears in browser 400 as shown in FIG. 4B indicating the included objects that are not yet fully loaded, and the percentage amount of being fully loaded. For this example, the user selects the first object in the list, www.advertiser.com/bigimage.gif, to stop the downloading of this object.

The user stops GET www.advertiser.com/bigimage.gif. Consequently, the client terminates the connection only to www.advertiser.com. The connection to www.nasa.com is still there. It should be noted, however, that there may be a side effect in that other images from a same server (e.g., advertiser.com) would also be stop even though just one object from that server was actually selected. This may occur as a result of the way in which the “keep alive” feature of HTTP 1.1 works. Typically, this is not a problem, since realistically, if one object has a slow download time from a particular server, then other objects from that same server will also be slow and probably will not have been fully downloaded.

The preferred embodiments may be implemented as a method, system, or article of manufacture using standard programming and/or engineering techniques to produce software, firmware, hardware, or any combination thereof. The term “article of manufacture” (or alternatively, “computer program product”) as used herein is intended to encompass data, instructions, program code, and/or one or more computer programs, and/or data files accessible from one or more computer usable devices, carriers, or media. Examples of computer usable mediums include, but are not limited to: nonvolatile, hard-coded type mediums such as CD-ROMs, DVDs, read only memories (ROMs) or erasable, electrically programmable read only memories (EEPROMs), recordable type mediums such as floppy disks, hard disk drives and CD-RW and DVD-RW disks, and transmission type mediums such as digital and analog communication links, or any signal bearing media. As such, the functionality of the above described embodiments of the invention can be implemented in hardware in a computer system and/or in software executable in a processor, namely, as a set of instructions (program code) in a code module resident in the random access memory of the computer. Until required by the computer, the set of instructions may be stored in another computer memory, for example, in a hard disk drive, or in a removable memory such as an optical disk (for use in a CD ROM) or a floppy disk (for eventual use in a floppy disk drive), or downloaded via the Internet or other computer network, as discussed above. The present invention applies equally regardless of the particular type of signal-bearing media utilized.

The foregoing description of the preferred embodiments of the invention has been presented for the purposes of illustration and description. It is not intended to be exhaustive or to limit the invention to the precise form disclosed. Many modifications and variations are possible in light of the above teaching. For example, although preferred embodiments of the invention have been described in terms of the Internet, other network environments including but not limited to wide area networks, intranets, and dial up connectivity systems using any network protocol that provides basic data transfer mechanisms may be used. In addition, although the invention has been described with respect to the stopping of the downloading of the selected objects, other embodiments may stop the download of objects not selected. That is, an object must be specifically selected to download it.

It is intended that the scope of the invention be limited not by this detailed description, but rather by the claims appended hereto. The above specification, examples and data provide a complete description of the manufacture and use of the system, method, and article of manufacture, i.e., computer program product, of the invention. Since many embodiments of the invention can be made without departing from the spirit and scope of the invention, the invention resides in the claims hereinafter appended.

Having thus described the invention, what we claim as new and desire to secure by Letters Patent is set forth in the following claims.

1. A method for stopping the download of an object included within a requested page being downloaded by an application program running on a computer system, the method comprising:
generating a displayable list of each object being downloaded within the requested page in response to a selectable item within the user interface of the application program;
enabling at least one object within the displayable list to be selectable; and
stopping the download of a given object depending upon a selected status of the given object.

2. The method of claim 1 wherein the selectable item is a stop button within the user interface for stopping the download of objects included within the requested page.

3. The method of claim 1 wherein the selected status is a state of being selected.

4. The method of claim 1 wherein the selected status is an unselected state.

5. The method of claim 3 further comprising rendering the requested page without each selected object.

6. The method of claim 3 further comprising rendering the requested page with only those unselected objects included in the rendering of the page.

7. The method of claim 1 wherein the displayable list further comprises an indication of an amount that each at least one object is downloaded.

8. An application program, on a computer usable medium having computer readable program code means for getting data from a remote computer system over a network and rendering the data on a local computer system running the application program, comprising:
program code means for generating a user interface having a stop button which inhibits the application program from continuing to get at least one included object within a requested page of data;
program code means for generating a displayable selectable list, via the user interface, of at least one object included within the requested page in response to a selection of the stop button; and
program code means for stopping the download of a given object within the list depending upon a selected status of the given object.

9. A computer system running an application program having means for retrieving a requested page of data from at least one remote computer system communicatively connected over a network and rendering the retrieved data on a display of the computer system, the computer system comprising:
means for generating a displayable list of each object being downloaded within the requested page in response to a selectable item within the user interface of the application program;
means for enabling at least one object within the displayable list to be selectable; and
means for stopping the download of a given object depending upon a selected status of the given object.

10. The computer system of claim 9 wherein the displayable list comprises an indication of an amount that each of the at least one object is currently downloaded.
